(19) United States
(12) Patent Application Publication
(10) Pub. No.: US 2025/0390715 A1
(43) Pub. Date: Dec. 25, 2025

(54) MULTIVARIATE TIME-SERIES LONG-TERM FORECASTING BASED ON MULTI-SCALE TEMPORAL FEATURE ENHANCEMENTS

(71) Applicant: ZHEJIANG UNIVERSITY, Zhejiang (CN)

(72) Inventors: Chenhao YING, Zhejiang (CN); Jiangang LU, Zhejiang (CN)

(21) Appl. No.: 18/930,597

(22) Filed: Oct. 29, 2024

(30) Foreign Application Priority Data
Jun. 21, 2024 (CN) 202410809349.3

(51) Int. Cl. G06N 3/0455; G06N 3/049; G06N 3/0499; G06N 3/088

(52) U.S. Cl. CPC G06N 3/0455; G06N 3/049; G06N 3/0499; G06N 3/088

(57) ABSTRACT

A method for multivariate time-series long-term forecasting based on multi-scale temporal feature enhancements, includes a time-series forcasting model TFEformer. The model utilizes a multi-branch structure and a patch-series attention mechanism to extract global and local time-series features at multiple temporal scales, and designs an adaptive feature fusion mechanism to achieve adaptive fusion of multi-scale temporal features. It employs an variate-wise attention mechanism and a redesigned gated feedforward network to perform feature fusion among multivariate variables and within the time-series, respectively. The time-series forcasting model TFEformer proposed by the present invention significantly improves the prediction of long-term trends in time-series and enhances the fitting ability for short-term local fluctuations, comprehensively increasing prediction accuracy across different prediction time lengths in multivariate time-series forcasting tasks.

### FIELD OF THE INVENTION

The present invention relates to the field of time-series forecasting, and specifically relates to a method for multivariate time-series long-term forecasting based on multi-scale temporal feature enhancements.

### BACKGROUND OF THE INVENTION

In the context of modern predictive model research, the problem of multivariable long-term time-series forecasting has consistently held a central position, especially given the extensive research demands in fields such as economics, finance, industry, energy and environmental monitoring. Time-series forecasting methods aim to forecast potential future trends in time-series by learning the latent features and patterns within historical time-series data. With the increasing complexity of forecasting model applications and higher demands for forecasting time, the problem of time-series forecasting has progressively evolved towards multivariable, long-term forecasting for complex systems. This evolution has concurrently heightened the requirements for forecasting models. As the number of variables involved in multivariate time-series increases, the influence of correlations among these variables on prediction results becomes more significant. Additionally, the task of long-term series forecasting greatly amplifies the difficulty of model prediction, presenting new challenges in the field of time-series forecasting.

In recent years, an increasing number of new methods based on deep learning have been proposed to address the aforementioned tasks of multivariable long-term time-series forecasting. However, limited by model structures and network depth, deep learning models have become increasingly inadequate in extracting long-range dependencies within time-series, making it difficult to achieve further breakthroughs. This situation persisted until the introduction of the Transformer architecture based on attention mechanisms, which provides a powerful tool for modeling long-term time-series forcasting due to its ability to extract dependencies regardless of distance. Recently, more methods have been developed to construct time-series forecasting models based on the Transformer method, achieving significant progress. Nevertheless, with deeper research, some deficiencies in the traditional Transformer structure have gradually surfaced. The latent features in time-series data are often contained within a segment of the time-series, but the embedding layer of the Transformer only vectorizes information from a single time step as the basic computational unit, failing to provide meaningful temporal feature information for the attention mechanism to extract correlations, thus limiting the performance of the attention mechanism. Furthermore, the Transformer structure only focuses on temporal dependencies at a single time scale and cannot perceive the diversity of temporal dependencies at different scales, which also limits the model's ability to simultaneously model both global and local information.

Many existing forecasting model methods attempt to address the inherent shortcomings of the Transformer architecture. The Sepformer model, proposed in patent CN114239718B, achieves hierarchical extraction of global and local temporal features through a discrete network architecture, but it still suffers from the limitations of the traditional single-step attention mechanism, failing to achieve high-precision forecasting. The latest paper “iTransformer: Inverted Transformers Are Effective for Time Series Forecasting” published at the International Conference on Learning Representations (ICLR) 2024, proposes the iTransformer model. This model extends the attention mechanism's computational unit to the global series through series embedding, addressing the issue of insufficient temporal information in the computational units of traditional attention mechanisms. However, due to the limitations of the embedding method, it cannot extract and model local information, which affects the model's short-term prediction and local fitting capabilities.

### SUMMARY OF THE INVENTION

The technical problem to be solved by the present invention is:
existing models suffer from poor time-series prediction accuracy due to deficiencies in the attention mechanism and the perception of multi-scale temporal dependencies, particularly in the long-term prediction tasks of multivariate time-series. To address this, the present invention proposes a method for multivariate time-series long-term forecasting based on multi-scale Temporal Feature Enhancements (TFE), and names the new method's architecture as the time-series forcasting model TFEformer. This model addresses two major deficiencies of existing time-series forcasting models that use Transformer and its improved architectures, significantly improving performance in long-term forecasting tasks for multivariate time-series.

The present invention adopts the following technical solution: A method for multivariate time-series long-term forecasting based on multi-scale temporal feature enhancements, comprising a time-series forcasting model TFEformer. The time-series forcasting model TFEformer consists of an Embedding module, a multi-layer Encoder, and a Decoder. It utilizes a multi-branch structure and patch-series attention mechanism to extract global and local time-series features at multiple temporal scales, employs an adaptive feature fusion mechanism to achieve adaptive fusion of multi-scale temporal features, and uses a variate-wise attention mechanism and a redesigned gated feedforward network to perform feature fusion among multivariate variables and within the time-series. The method comprises the following steps:
Step 1: acquiring a multivariate time-series dataset, preprocessing the multivariate time-series dataset, and partitioning the multivariate time-series dataset into a training dataset and a validation dataset according to the model training requirements and a preset ratio;
Step 2: utilizing the training dataset obtained in step 1, performing grouping and reconstruction by segmenting the continuous time-series into multiple groups of data composed of historical sequences and prediction sequences; randomly selecting N groups of data each time, and inputting the historical sequences from each group into the Embedding module of the time-series forcasting model TFEformer; using a multi-branch structure, performing vectorized feature representation and dimensional transformation on global features and local patch features, and pairing and concatenating the transformed global series features and local patch features;
Step 3: sending the paired and concatenated global and local patch features into the Encoder for further feature extraction and representation to obtain a temporal feature vector containing all feature information, wherein the Encoder comprises a patch-series attention layer, an adaptive fusion layer, an variate-wise attention layer, and a gated feedforward network layer;
Step 4: sending the temporal feature vector obtained in step 3 into the Decoder, reconstructing the feature vector and adjusting its shape using a linear projection network, thereby obtaining the generated prediction sequence based on training dataset;
Step 5: calculating the mean squared error (MSE) between the actual prediction sequence in the training dataset and the generated prediction sequence obtained in step 4, then with the optimization objective of minimizing the MSE, performing backpropagation through the Adam optimizer to update the network parameters; obtaining the trained time-series forecasting model TFEformer;
Step 6: using the obtained validation dataset obtained in step 1, performing grouping and reconstruction using the same method as step 2; sending the reconstructed validation dataset into the trained time-series forecasting model TFEformer trained in step 5 using the same data input method as step 2 to obtain the generated prediction sequence based on the validation dataset;
Step 7: calculating the mean squared error (MSE) between the actual prediction sequence based on validation dataset and the generated prediction sequence obtained in step 6;
Step 8: repeating steps 2 to 7 until the MSE of the validation set no longer decreases, indicating that the model performance has reached its optimal level, at which point the network parameter updating and model training are complete, obtaining the optimal time series prediction model TFEformer;
Step 9: sending the given input sequence for the forecasting task into the optimal time-series forecasting model TFEformer obtained in step 8 to perform prediction, outputting the generated prediction sequence, and complete the forecasting task.

Furthermore, the specific method steps for data grouping and reconstruction in step 2 comprising:
Step 2.1: for the training dataset, setting the historical sequence length and prediction sequence length of the forecasting task according to the requirements, corresponding to two parts in each group of data: the historical sequence and the prediction sequence;
Step 2.2: utilizing a sliding window mechanism to group the dataset, with the window length being the sum of the historical sequence length and the prediction sequence length. Each time, the window is moved one position to segment the dataset, resulting in a series of continuous data with a length equal to the window length, differing only in the first and last data points. Each resulting group of continuous data is then divided into a historical sequence and a prediction sequence according to the lengths, and both are encapsulated together as a group of data;
Step 2.3: randomly selecting N groups of data and inputting them into the time-series forecasting model TFEformer, where Nis an integer greater than or equal to 16.

Furthermore, in step 2, the Embedding module requires inputting historical sequences from each set of input data, and performing vectorized feature expression and dimensional transformation on them; performing the vectorization of the input data in two directions: multi-scale patch vectorization and series vectorization, which are implemented by the multi-scale patch embedding layer and the series embedding layer, the specific steps are as follows:
Step 2.4: multi-scale sequence segmentation, where the multi-scale patch embedding layer divides the input sequence at different scales through a multi-branch structure, each branch generates a set of patch blocks of different lengths and numbers, and uses a linear network to map to the embedding vector dimension, the process can be described by the formula as:

$$\begin{matrix}\{ {x}_{1 , n}^{( {b}_{n} )} , {x}_{2 , n}^{( {b}_{n} )} , … , {x}_{{N}_{{b}_{n}} , n}^{( {b}_{n} )} \} = {Patched}_{{b}_{n}} ( {X}_{: , n} ) \\ {P}_{n , {b}_{n}}^{0} = PatchEmbed ( {x}_{1 , n}^{( {b}_{n} )} , {x}_{2 , n}^{( {b}_{n} )} , … , {x}_{{N}_{{b}_{n}} , n}^{( {b}_{n} )} )\end{matrix}$$

where, N_{b}_{ₙ} is the number of patches under the bₙ-th branch, X_{:,n} is the historical sequence of the n-th variate, Patc [symbol] ed is a sequence segmentation operator,

$${x}_{{N}_{{b}_{n}} , n}^{( {b}_{n} )}$$

is the N_{b}_{ₙ}-th patch vector segmented under the bₙ-th branch, Patc [symbol] Embed is a patch embedding operator,

$${P}_{n , {b}_{n}}^{0}$$

is the local patch vectors set generated by the bₙ-th branch of the n-th variate, including N_{b}_{ₙ} sub-vectors;
Step 2.5: series vectorization, where the series embedding layer vectorizes the time-series of each variate separately through a fully connected linear projection, which can be described by the formula:

$${S}_{n}^{0} = SeriesEmbed ( {X}_{: , n} )$$

where

$${S}_{n}^{0}$$

is the global series vector obtained by series vectorization of the n-th variate, and SeriesEmbed is a series embedding operator;
Step 2.6: vectorization pairing, which pair local patch vectors set and global series vectors generated by multi-scale patch vectorization and series vectorization, and sending them to subsequent network modules for fusion.

Furthermore, the patch-series attention layer in step 3 utilizing the attention mechanism between the local patch vectors and the global series vector for feature fusion, integrating fine-grained local patch information into the global information of the global series vector, thereby forming an information-riched temporal feature vector, which can be represented by the following equation:

$${P}_{n , {b}_{n}}^{l + 1} , {V}_{n , {b}_{n}}^{l} = Norm ( [ {P}_{n , {b}_{n}}^{l} ; {S}_{n}^{l} ] + Attn ( [ {P}_{n , {b}_{n}}^{l} ; {S}_{n}^{l} ] ) )$$

where l is the current layer number of the Encoder,

$${P}_{n , {b}_{n}}^{l}$$

is the local patch vectors set generated by the bₙ-th branch of the n-th variate,

$${S}_{n}^{l}$$

is the global series vector of the n-th variate, Norm is a layer normalization operator, Attn is a attention operator,

$${P}_{n , {b}_{n}}^{l + 1}$$

represents the refined patch vector set, which is used for the input of the encoder at the next layer, and

$${V}_{n , {b}_{n}}^{l}$$

is the fused temporal enrichment feature vector, representing the temporal information obtained by fusing local and global features at different time scales, which is used for multi-scale fusion of subsequent modules.

Furthermore, the adaptive fusion layer, variate-wise attention layer, and gated feedforward network layer in step 3 collectively forming a self-learning weight allocation mechanism, which is used to automatically determine the contribution of temporal features at each scale to the final output prediction value, achieving the fusion of multi-scale temporal features, the specific steps comprising:

Step 3.1: self-weight generation, which flattens the Bₙ temporal enrichment feature vectors generated in the patch-series attention layer into a flattened vector Ξ∈ [symbol] ^{1×B}^{ₙ}^{D} denoted as

$$= [ {V}_{n , 1}^{l} ; {V}_{n , 2}^{l} ; … ; {V}_{n , {B}_{n}}^{l} ] ;$$

then utilizing a gated feedforward network for dimensionality reduction, compressing it into a Bₙ-dim vector; finally, a Softmax layer is used for weight calculation, resulting in trainable weight proportions, which can be expressed as the formula:

$${W}_{n}^{l} = [ {w}_{n , 1}^{l} , {w}_{n , 2}^{l} , , {w}_{n , {B}_{n}}^{l} ] = softmax ( GFFN ( ) )$$

where

$${W}_{n}^{l}$$

is the weight matrix of the n-th variate,

$${w}_{n , {b}_{n}}^{l}$$

is the weight assigned to each temporal enriched feature vector

$${V}_{n , {b}_{n}}^{l} ,$$

softmax is a exponential normalization operator, GFFN is the gated feedforward network layer, and Bₙ is the total number of branches;
Step 3.2: feature vectors augmentation, which utilizes the gated feedforward network to perform nonlinear control on the Bₙ temporal enrichment feature vectors generated in the patch-series attention layer, and further promotes their feature expression, which can be represented by the formula:

$${\tilde{V}}_{n , {b}_{n}}^{l} = GFFN ( {V}_{n , {b}_{n}}^{l} )$$

where

$${V}_{n , {b}_{n}}^{l}$$

is the bₙ-th temporal enriched feature vector of the n-th variate generated in the patch-series attention layer,

$${\tilde{V}}_{n , {b}_{n}}^{l}$$

is the modified bₙ-th temporal enriched feature vector of the n-th variable;
Step 3.3: feature fusion, which employs self-learning weights

$${w}_{n , {b}_{n}}^{l}$$

for further modified feature vector

$${\tilde{V}}_{n , {b}_{n}}^{l}$$

to perform weight allocation, and then the weighted sum is calculated to obtain the fused full-scale temporal feature vector, which can be expressed as the formula:

$${\tilde{V}}_{n}^{l} = {\sum }_{{b}_{n} = 1}^{{B}_{n}} {w}_{n , {b}_{n}}^{l} {\tilde{V}}_{n , {b}_{n}}^{l}$$

where

$${\tilde{V}}_{n}^{l}$$

is the fused full-scale temporal feature vector.

Furthermore, the variate-wise attention layer utilizing the attention mechanism among multivariate variables for correlation fusion, and said gated feedforward network layer introducing a gating mechanism into the feedforward network, enabling it to adaptively skip or limit unfavorable nonlinear activations and excessively deep structures, which can be expressed as the formula:

$$\begin{matrix}{h}_{1} = GELU ( {w}_{1} {V}_{n}^{l} + {b}_{1} ) \\ {h}_{2} = {w}_{2} {h}_{1} + {b}_{2} \\ GLU ( {h}_{2} ) = σ ( {w}_{3} {h}_{2} + {b}_{3} ) ⊙ ( {w}_{4} {h}_{2} + {b}_{4} ) \\ GFFN ( {V}_{n}^{l} ) = Norm ( {V}_{n}^{l} + GLU ( {h}_{2} ) )\end{matrix}$$

where

$${V}_{n}^{l}$$

represents the input data stream of the module, σ(⋅) and GELU(⋅) are the activation functions, h₁ and h₂ are intermediate variates, w and b are learnable parameters, GLU is the gated linear unit, ⊙ is a matrix dot-product operator, and

$$GFFN ( {V}_{n}^{l} )$$

is the output of the module.

Furthermore, in step 4, a linear projection layer is used as the decoder of the model to reconstruct the generated temporal feature vectors with highly enriched feature information generated in step 3 and adjust the vector length. By utilizing a linear fully connected neural network, the feature vectors are spatially mapped to obtain the final predicted sequence of the specified length.

Furthermore, the formula for calculating the mean square error MSE as described in step 5 is:

$$MSE = \frac{1}{n} {\sum }_{i = 1}^{n} {( y - \hat{y} )}^{2}$$

where y is the prediction value and ŷ is the true value, and n denotes the length of sequence.

Further, the present invention adopts the following technical solution:

A non-transitory computer-readable storage medium having a computer program stored thereon, wherein when said computer program is executed by a processor, causing said processor to carry out said method for multivariate time-series long-term forecasting based on multi-scale temporal feature enhancements.

Further, the present invention adopts the following technical solution:

An electronic device comprising a memory, a processor and a computer program stored on said memory and runnable on said processor, wherein when said processor executes said computer program, causing said processor to carry out said method for multivariate time-series long-term forecasting based on multi-scale temporal feature enhancements.

The beneficial effects of the present invention are:

The present invention utilizes a multi-branch structure and patch-series attention mechanism to extract global and local time-series features at multiple temporal scales. An adaptive feature fusion mechanism is designed to achieve the adaptive fusion of multi-scale temporal features, enhancing the model's ability to predict long-term time-series trends while reducing the prediction error for short-term local fluctuations. The use of an variate-wise attention fusion mechanism and a redesigned gated feedforward network enables the fusion of features among multivariate variables and within the time-series, respectively. This improves the model's prediction accuracy for multivariate time-series and enhances its robustness and resistance to interference in long-term time-series forcasting tasks, thereby significantly improving prediction performance.

### BRIEF DESCRIPTION OF THE DRAWINGS

FIG. 1 shows a schematic diagram of the overall structure of the embodiment of the present invention;

FIG. 2 shows a model structure framework of the embodiment of the present invention;

FIG. 3 shows a schematic diagram of the multi-scale patch embedding mechanism of the present invention;

FIG. 4 shows a network structure and data flow diagram of the patch-series attention layer of the present invention;

FIG. 5 shows a network structure and data flow diagram of the adaptive fusion layer and the self-learning weight allocation mechanism of the present invention;

FIG. 6 shows a network structure diagram of gated feedforward network layer of the present invention;

FIG. 7 shows the comparison of prediction performance between the embodiment of the present invention and four existing methods on five public datasets: ETTh1, ETTh2, ETTm1, Weather, and ECL.

### DETAILED DESCRIPTION OF THE INVENTION

The present invention is hereinafter described in detail with reference to the embodiments and accompanying drawings:

A method for multivariate time-series long-term forecasting based on multi-scale temporal feature enhancements (TFEformer). The method comprises the following steps:
Step 1: acquiring a multivariate time-series dataset, preprocessing the multivariate time-series dataset, and partitioning 70% of the data as the training dataset and 30% as the validation dataset.

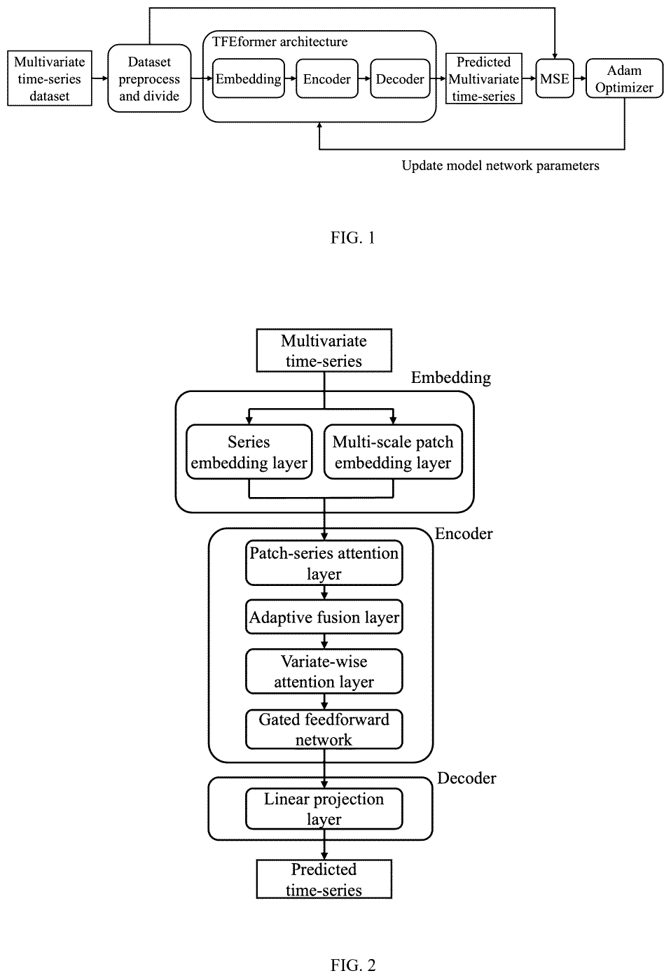

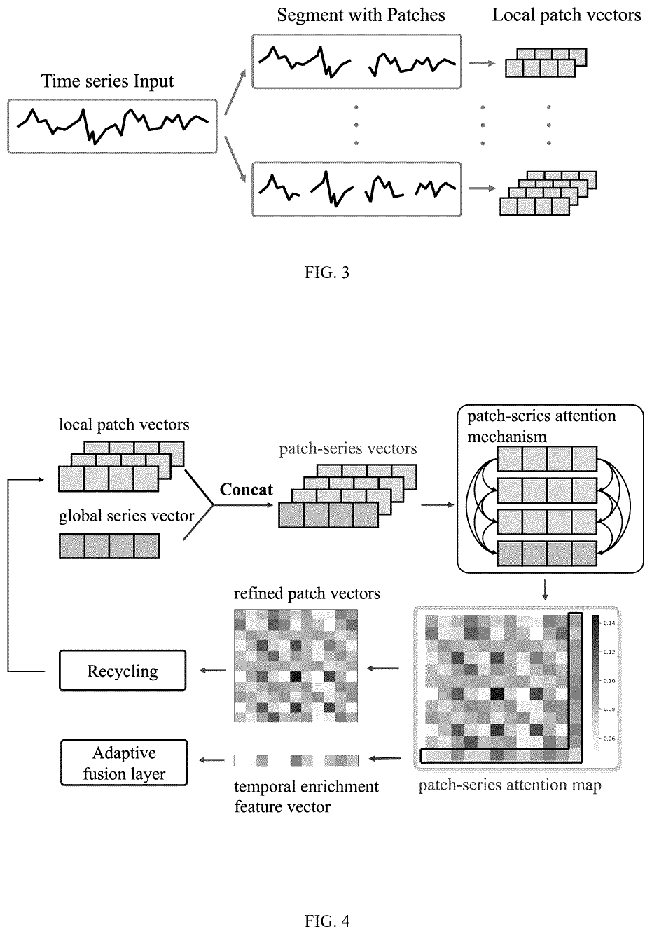

As shown in FIG. 1, the overall structure of the present invention is illustrated. The data processing and dataset partitioning section is located at the front of the structural diagram and is responsible for the preliminary processing of raw data to form the data structure required by the forecasting model.

Step 2: utilizing the training dataset obtained in step 1, performing grouping and reconstruction by segmenting the continuous time-series into multiple groups of data composed of historical sequences and prediction sequences; randomly selecting 32 groups of data each time, and inputting the historical sequences from each group into the time-series forcasting model TFEformer.

The specific method steps for data grouping and reconstruction comprising:
Step 2.1: for the training dataset, setting the historical sequence length and prediction sequence length of the forecasting task according to the requirements, corresponding to two parts in each group of data: the historical sequence and the prediction sequence;
Step 2.2: utilizing a sliding window mechanism to group the dataset, with the window length being the sum of the historical sequence length and the prediction sequence length. Each time, the window is moved one position to segment the dataset, resulting in a series of continuous data with a length equal to the window length, differing only in the first and last data points. Each resulting group of continuous data is then divided into a historical sequence and a prediction sequence according to the lengths, and both are encapsulated together as a group of data;
Step 2.3: randomly selecting N groups of data and inputting them into the time-series forecasting model TFEformer, where Nis an integer greater than or equal to 16.

As shown in FIG. 2, the time-series forcasting model TFEformer consists of an Embedding module, a multi-layer Encoder, and a Decoder.

Inputting the historical sequences from each group into the Embedding module of the time-series forcasting model TFEformer; using a multi-branch structure, performing vectorized feature representation and dimensional transformation on global features and local patch features, and pairing and concatenating the transformed global series features and local patch features; performing the vectorization of the input data in two directions: multi-scale patch vectorization and series vectorization, which are implemented by the multi-scale patch embedding layer and the series embedding layer, the specific steps are as follows:
Step 2.4: multi-scale sequence segmentation, where the multi-scale patch embedding layer divides the input sequence at different scales through a multi-branch structure, each branch generates a set of patch blocks of different lengths and numbers, and uses a linear network to map to the embedding vector dimension, the process can be described by the formula as:

$$\begin{matrix}\{ {x}_{1 , n}^{( {b}_{n} )} , {x}_{2 , n}^{( {b}_{n} )} , … , {x}_{{N}_{{b}_{n}} , n}^{( {b}_{n} )} \} = {Patched}_{{b}_{n}} ( {X}_{: , n} ) \\ {P}_{n , {b}_{n}}^{0} = PatchEmbed ( {x}_{1 , n}^{( {b}_{n} )} , {x}_{2 , n}^{( {b}_{n} )} , … , {x}_{{N}_{{b}_{n}} , n}^{( {b}_{n} )} )\end{matrix}$$

where, N_{b}_{ₙ} is the number of patches under the bₙ-th branch, X_{:,n} is the historical sequence of the n-th variate, Patc [symbol] ed is a sequence segmentation operator,

$${x}_{{N}_{{b}_{n}} , n}^{( {b}_{n} )}$$

is the N_{b}_{ₙ}-th patch vector segmented under the bₙ-th branch, Patc [symbol] Embed is a patch embedding operator,

$${P}_{n , {b}_{n}}^{0}$$

is the local patch vectors set generated by the bₙ-th branch of the n-th variate including N_{b}_{ₙ} sub-vectors;
Step 2.5: series vectorization, where the series embedding layer vectorizes the time-series of each variate separately through a fully connected linear projection, which can be described by the formula:

$${S}_{n}^{0} = SeriesEmbed ( {X}_{: , n} )$$

where

$${S}_{n}^{0}$$

is the global series vector obtained by series vectorization of the n-th variate, and SeriesEmbed is a series embedding operator;
Step 2.6: vectorization pairing, which pair local patch vectors set and global series vectors generated by multi-scale patch vectorization and series vectorization, and sending them to subsequent network modules for fusion.
Step 3: sending the paired and concatenated global and local patch features into the Encoder for further feature extraction and representation to obtain a temporal feature vector containing all feature information.

As shown in FIG. 2, the Encoder of the model in step 3 is primarily used for further feature extraction and representation of the global series vector and local patch vectors generated in step 2. It consists of the following components: a patch-series attention layer, an adaptive fusion layer, an variate-wise attention layer, and a gated feedforward network layer.

As shown in FIG. 4, the patch-series attention layer utilizes the attention mechanism between the local patch vectors and the global series vector for feature fusion, integrating fine-grained local patch information into the global information of the global series vector, thereby forming an information-riched temporal feature vector. This can be represented by the following equation:

$${P}_{n , {b}_{n}}^{l + 1} {V}_{n , {b}_{n}}^{l} = Norm ( [ {P}_{n , {b}_{n}}^{l} ; {S}_{n}^{l} ] + Attn ( [ {P}_{n , {b}_{n}}^{l} ; {S}_{n}^{l} ] ) )$$

where l is the current layer number of the Encoder,

$${P}_{n , {b}_{n}}^{l}$$

is the local patch vectors set generated by the bₙ-th branch of the n-th variate,

$${S}_{n}^{l}$$

is the global series vector of the n-th variate, Norm is a layer normalization operator, Attn is a attention operator,

$${P}_{n , {b}_{n}}^{l + 1}$$

represents the refined patch vector set, which is used for the input of the encoder at the next layer, and

$${V}_{n , {b}_{n}}^{l}$$

is the temporal enrichment feature vector, which represents the temporal information at this scale, which is used for multi-scale fusion of subsequent modules.

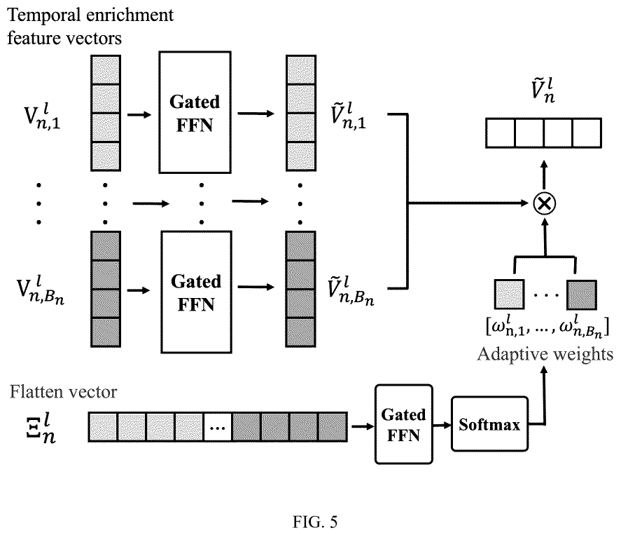

As shown in FIG. 5, the adaptive fusion layer, variate-wise attention layer, and gated feedforward network layer in the Encoder collectively forming a self-learning weight allocation mechanism, which is used to automatically determine the contribution of temporal features at each scale to the final output prediction value, achieving the fusion of multi-scale temporal features, the specific steps comprising:
Step 3.1: self-weight generation, which flattens the Bₙ temporal enrichment feature vectors generated in the previous module into a flattened vector Ξ∈ [symbol] ^{1×B}^{ₙ}^{D} denoted as

$${Ξ}_{n}^{l} [ {V}_{n , 1}^{l} ; {V}_{n , 2}^{l} ; … ; {V}_{n , {B}_{n}}^{l} ] ;$$

then utilizing a gated feedforward network for dimensionality reduction, compressing it into a Bₙ-dim vector; finally, a Softmax layer is used for weight calculation, resulting in trainable weight proportions, which can be expressed as the formula:

$${W}_{n}^{l} = [ {w}_{n , 1}^{l} , {w}_{n , 2}^{l} , … , {w}_{n , {B}_{n}}^{l} ] = softmax ( GFFN ( {Ξ}_{n}^{l} ) )$$

where

$${W}_{n}^{l}$$

is the weight matrix of the n-th variate,

$${w}_{n , {b}_{n}}^{l}$$

is the weight assigned to each temporal enriched feature vector

$${V}_{n , {b}_{n}}^{l} ,$$

softmax is a exponential normalization operator, GFFN is the gated feedforward network layer, and Bₙ is the total number of branches;
Step 3.2: feature vectors augmentation, which utilizes the gated feedforward network to perform nonlinear control on the Bₙ temporal enrichment feature vectors generated in the previous module, and further promotes their feature expression, which can be represented by the formula:

$${\tilde{V}}_{n , {b}_{n}}^{l} = GFFN ( {V}_{n , {b}_{n}}^{l} )$$

where

$${V}_{n , {b}_{n}}^{l}$$

is the bₙ-th temporal enriched feature vector of the n-th variate generated in the patch-series attention layer,

$${\tilde{V}}_{n , {b}_{n}}^{l}$$

is the modified bₙ-th temporal enriched feature vector of the n-th variable;
Step 3.3: feature fusion, which employs self-learning weights

$${w}_{n , {b}_{n}}^{l}$$

for further modified feature vector

$${\tilde{V}}_{n , {b}_{n}}^{l}$$

to perform weight allocation, and then the weighted sum is calculated to obtain the fused full-scale temporal feature vector, which can be expressed as the formula:

$${\tilde{V}}_{n}^{l} = {\sum }_{{b}_{n} = 1}^{{B}_{n}} {w}_{n , {b}_{n}}^{l} {\tilde{V}}_{n , {b}_{n}}^{l}$$

where

$${\tilde{V}}_{n}^{l}$$

is the fused full-scale temporal feature vector.

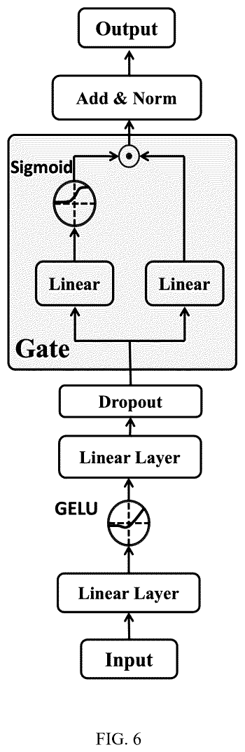

Said variate-wise attention layer utilizing the attention mechanism among multivariate variables for correlation fusion; and as shown in FIG. 6, said gated feedforward network layer introducing a gating mechanism into the feedforward network, enabling it to adaptively skip or limit unfavorable nonlinear activations and excessively deep structures, which can be expressed as a formula:

$${h}_{1} = G E L U ( {w}_{1} {V}_{n}^{l} + {b}_{1} )$$

$${h}_{2} = {w}_{2} {h}_{1} + {b}_{2}$$

$$GLU ( {h}_{2} ) = σ ( {w}_{3} {h}_{2} + {b}_{3} ) ⊙ ( {w}_{4} {h}_{2} + {b}_{4} )$$

$$GFFN ( {V}_{n}^{l} ) = Norm ( {V}_{n}^{l} + GLU ( {h}_{2} ) )$$

where

$${V}_{n}^{l}$$

represents the input data stream of the module, σ(⋅) and GELU(⋅) are the activation functions, h₁ and h₂ are intermediate variates, w and b are learnable parameters, GLU is the gated linear unit, ⊙ is a matrix dot-product operator, and

$$GFFN ( {V}_{n}^{l} )$$

is the output of the module.

Step 4: sending the temporal feature vector obtained in step 3 into the Decoder, reconstructing the feature vector and adjusting its shape using a linear projection network, thereby obtaining the generated prediction sequence based on training dataset.

As shown in FIG. 2, a linear projection layer is used as the decoder of the model in step 4 to reconstruct the generated temporal feature vectors with highly enriched feature information generated in step 3 and adjust the vector length. By utilizing a linear fully connected neural network, the feature vectors are spatially mapped to obtain the final predicted sequence of the specified length.

Step 5: calculating the mean squared error (MSE) between the actual prediction sequence in the training dataset and the generated prediction sequence obtained in step 4, then with the optimization objective of minimizing the MSE, performing backpropagation through the Adam optimizer to update the network parameters; obtaining the trained time-series forecasting model TFEformer; the formula for calculating the mean square error MSE is:

$$M S E = \frac{1}{n} {\sum }_{i = 1}^{n} {( y - \hat{y} )}^{2}$$

where y is the prediction value and ŷ is the true value, and n denotes the length of sequence.

Step 6: using the obtained validation dataset obtained in step 1, performing grouping and reconstruction using the same method as step 2; sending the reconstructed validation dataset into the trained time-series forecasting model TFEformer trained in step 5 using the same data input method as step 2 to obtain the generated prediction sequence based on the validation dataset.

Step 7: calculating the mean squared error (MSE) between the actual prediction sequence based on validation dataset and the generated prediction sequence obtained in step 6.

Step 8: repeating steps 2 to 7 until the MSE of the validation set no longer decreases, indicating that the model performance has reached its optimal level, at which point the network parameter updating and model training are complete, obtaining the optimal time series prediction model TFEformer.

Step 9: sending the given input sequence for the forecasting task into the optimal time-series forecasting model TFEformer obtained in step 8 to perform prediction, outputting the generated prediction sequence, and complete the forecasting task.

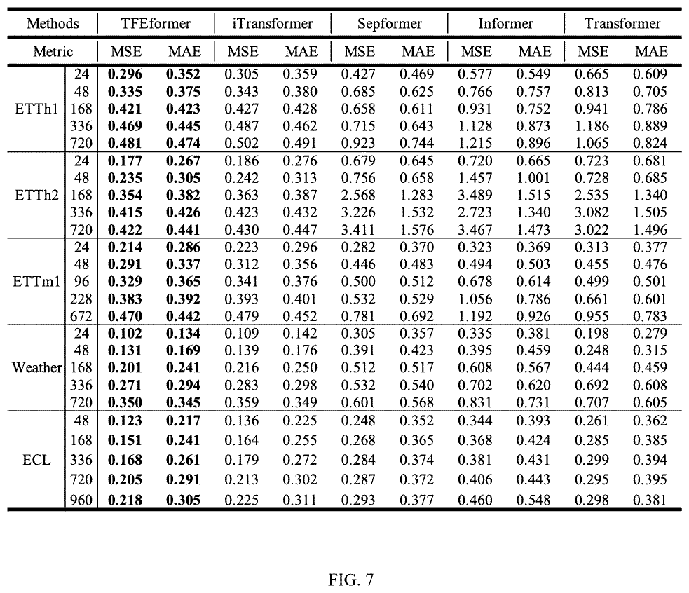

FIG. 7 displays the experimental results of five methods-TFEformer, iTransformer, Sepformer, Informer, and Transformer-on five datasets: ETTh1, ETTh2, ETTm1, Weather, and ECL, under the same experimental conditions. The evaluation metrics are mean squared error (MSE) and mean absolute error (MAE). In each experimental condition, the results of the best-performing model are highlighted in bold in the table. As shown in FIG. 7, the proposed time-series forecasting model TFEformer achieves optimal performance across all forecasting tasks on all datasets, with significant performance improvements compared to other models. Compared to the current best-performing iTransformer model, the proposed time-series forecasting model TFEformer reduces the mean squared error (MSE) by 3.1%, 2.5%, 3.5%, 4.6%, and 5.7% on the five datasets, respectively. Compared to the Sepformer model proposed in patent CN114239718B, the TFEformer reduces the mean squared error (MSE) by 41.2%, 84.8%, 33.6%, 54.9%, and 37.3% on the five datasets, respectively. Compared to the baseline Transformer model, the TFEformer reduces the mean squared error (MSE) by 57.1%, 84.1%, 41.5%, 53.9%, and 39.8% on the five datasets, respectively. These reductions in prediction error demonstrate that the proposed time-series forecasting model TFEformer achieves the best performance in long-term multivariate time-series forecasting tasks and significantly outperforms existing models.

From the above detailed description of the invention, it is clear to those skilled in the art that the implementation of the present invention can be achieved with the help of software and the necessary hardware platform. Embodiments of the present invention can be implemented by using the existing processor, or by a dedicated processor being used for this or other purposes in an appropriate system, or by a hardwired system. Embodiments of the present invention also include a non-transitory computer-readable storage medium comprising a machine-readable medium for carrying or having machine-executable instructions or data structures stored thereon; the machine-readable medium can be any available medium accessible by a general purpose or the dedicated computer or other machines with a processor. By way of example, the machine-readable medium includes RAM, ROM, EPROM, EEPROM, CD-ROM or other optical disk memory, disk memory or other magnetic storage devices, or any other medium that can carry or store the required computer program code in the form of machine-executable instructions or data structures, and that can be accessed by a general purpose or the dedicated computer or other machines with a processor. When information is transmitted or made available to a machine over a network or other communication connection (hardwired, wireless, or a combination of hardwired and wireless), the connection is also considered a machine-readable medium.

It should be appreciated that the foregoing is only preferred embodiments of the invention and is not for use in limiting the invention. Any modification, equivalent substitution, and improvement without departing from the spirit and principle of this invention should be covered in the protection scope of the invention.

1. A method for multivariate time-series long-term forecasting based on multi-scale temporal feature enhancements, characterized by comprising a time-series forcasting model TFEformer, which consists of an Embedding module, a multi-layer Encoder, and a Decoder, utilizing a multi-branch structure and patch-series attention mechanism to extract global and local time-series features at multiple temporal scales, employing an adaptive feature fusion mechanism to achieve the fusion of multi-scale temporal features, using an variate-wise attention mechanism and a redesigned gated feedforward network to perform feature fusion among multivariate variables and within the time-series, said method comprising:
Step 1: acquiring a multivariate time-series dataset, preprocessing the multivariate time-series dataset, and partitioning the multivariate time-series dataset into a training dataset and a validation dataset according to the model training requirements and a preset ratio;
Step 2: utilizing the training dataset obtained in step 1, performing grouping and reconstruction by segmenting the continuous time-series into multiple groups of data composed of historical sequences and prediction sequences; randomly selecting N groups of data each time, and inputting the historical sequences from each group into the Embedding module of the time-series forcasting model TFEformer; using a multi-branch structure, performing vectorized feature representation and dimensional transformation on global features and local patch features, and pairing and concatenating the transformed global series features and local patch features;
Step 3: sending the paired and concatenated global and local patch features into the Encoder for further feature extraction and representation to obtain a temporal feature vector containing all feature information, wherein the Encoder comprises a patch-series attention layer, an adaptive fusion layer, an variate-wise attention layer, and a gated feedforward network layer;
Step 4: sending the temporal feature vector obtained in step 3 into the Decoder, reconstructing the feature vector and adjusting its shape using a linear projection network, thereby obtaining the generated prediction sequence based on training dataset;
Step 5: calculating the mean squared error (MSE) between the actual prediction sequence in the training dataset and the generated prediction sequence obtained in step 4, then with the optimization objective of minimizing the MSE, performing backpropagation through the Adam optimizer to update the network parameters; obtaining the trained time-series forecasting model TFEformer;
Step 6: using the obtained validation dataset obtained in step 1, performing grouping and reconstruction using the same method as step 2; sending the reconstructed validation dataset into the trained time-series forecasting model TFEformer trained in step 5 using the same data input method as step 2 to obtain the generated prediction sequence based on the validation dataset;
Step 7: calculating the mean squared error (MSE) between the actual prediction sequence based on validation dataset and the generated prediction sequence obtained in step 6;
Step 8: repeating steps 2 to 7 until the MSE of the validation set no longer decreases, indicating that the model performance has reached its optimal level, at which point the network parameter updating and model training are complete, obtaining the optimal time series prediction model TFEformer;
Step 9: sending the given input sequence for the forecasting task into the optimal time-series forecasting model TFEformer obtained in step 8 to perform prediction, outputting the generated prediction sequence, and complete the forecasting task.

2. The method as claimed in claim 1 wherein said dataset grouping and reconstruction in step 2 comprising:
Step 2.1: for the training dataset, setting the historical sequence length and prediction sequence length of the forecasting task according to the requirements, corresponding to two parts in each group of data: the historical sequence and the prediction sequence;
Step 2.2: utilizing a sliding window mechanism to group the dataset, with the window length being the sum of the historical sequence length and the prediction sequence length. Each time, the window is moved one position to segment the dataset, resulting in a series of continuous data with a length equal to the window length, differing only in the first and last data points. Each resulting group of continuous data is then divided into a historical sequence and a prediction sequence according to the lengths, and both are encapsulated together as a group of data;
Step 2.3: randomly selecting N groups of data and inputting them into the time-series forecasting model TFEformer, where N is an integer greater than or equal to 16.

3. The method as claimed in claim 1 wherein said Embedding module in step 2 requires inputting historical sequences from each set of input data, and performing vectorized feature expression and dimensional transformation on them; performing the vectorization of the input data in two directions: multi-scale patch vectorization and series vectorization, which are implemented by the multi-scale patch embedding layer and the series embedding layer, the specific steps are as follows:
Step 2.4: multi-scale sequence segmentation, where the multi-scale patch embedding layer divides the input sequence at different scales through a multi-branch structure, each branch generates a set of patch blocks of different lengths and numbers, and uses a linear network to map to the embedding vector dimension, the process can be described by the formula as:
$$\{ \begin{matrix}\begin{matrix}\begin{matrix}{x}_{1 , n}^{( {b}_{n} )} , & {x}_{2 , n}^{( {b}_{n} )}\end{matrix} & , … ,\end{matrix} & {x}_{{N}_{{b}_{n} ,} n}^{( {b}_{n} )}\end{matrix} \} = {Patched}_{{b}_{n}} ( {X}_{: , n} )$$
$${P}_{n , {b}_{n}}^{0} = PatchEmbed ( \begin{matrix}{x}_{1 , n}^{( {b}_{n} )} & {x}_{2 , n}^{( {b}_{n} )} & , … , & {x}_{{N}_{{b}_{n} , n}}^{( {b}_{n} )}\end{matrix} )$$
where, N_{b}_{ₙ} is the number of patches under the bₙ-th branch, X_{:,n} is the historical sequence of the n-th variate, Patc [symbol] ed is a sequence segmentation operator,
$${x}_{{N}_{{b}_{n} , n}}^{( {b}_{n} )}$$
is the N_{b} _{ₙ}-th patch vector segmented under the bₙ-th branch, Patc [symbol] Embed is a patch embedding operator,
$${P}_{n , {b}_{n}}^{0}$$
is the local patch vectors set generated by the bₙ-th branch of the n-th variate, including N_{b}_{ₙ} sub-vectors;
Step 2.5: series vectorization, where the series embedding layer vectorizes the time-series of each variate separately through a fully connected linear projection, which can be described by the formula:
$${S}_{n}^{0} = S e r i e s E m b e d ( {X}_{: , n} )$$
where
$${S}_{n}^{0}$$
is the global series vector obtained by series vectorization of the n-th variate, and SeriesEmbed is a series embedding operator;
Step 2.6: vectorization pairing, which pair local patch vectors set and global series vectors generated by multi-scale patch vectorization and series vectorization, and sending them to subsequent network modules for fusion.

4. The method as claimed in claim 1 wherein said patch-series attention layer in step 3 utilizing the attention mechanism between the local patch vectors and the global series vector for feature fusion, integrating fine-grained local patch information into the global information of the global series vector, thereby forming an information-riched temporal feature vector, which can be represented by the following equation:
$${P}_{n , {b}_{n}}^{l + 1} , {V}_{n , {b}_{n}}^{l} = Norm ( [ {P}_{n , {b}_{n}}^{l} ; {S}_{n}^{l} ] + Attn ( [ {P}_{n , {b}_{n}}^{l} ; {S}_{n}^{l} ] ) )$$
where l is the current layer number of the Encoder,
$${P}_{n , {b}_{n}}^{l}$$
is the local patch vectors set generated by the bₙ-th branch of the n-th variate,
$${S}_{n}^{l}$$
is the global series vector of the n-th variate, Norm is a layer normalization operator, Attn is a attention operator,
$${P}_{n , {b}_{n}}^{l + 1}$$
represents the refined patch vector set, which is used for the input of the encoder at the next layer, and
$${V}_{n , {b}_{n}}^{l}$$
is the fused temporal enrichment feature vector, representing the temporal information obtained by fusing local and global features at different time scales, which is used for multi-scale fusion of subsequent modules.

5. The method as claimed in claim 1 wherein said adaptive fusion layer, variate-wise attention layer, and gated feedforward network layer in step 3 collectively forming a self-learning weight allocation mechanism, which is used to automatically determine the contribution of temporal features at each scale to the final output prediction value, achieving the fusion of multi-scale temporal features, the specific steps comprising:
Step 3.1: self-weight generation, which flattens the Bₙ temporal enrichment feature vectors generated in the patch-series attention layer into a flattened vector Ξ∈ [symbol] ^{1×B}^{ₙ}^{D}, denoted as
$${Ξ}_{n}^{l} = [ {V}_{n , 1}^{l} ; {V}_{n , 2}^{l} ; … ; {V}_{n {B}_{n}}^{l} ] ;$$
then utilizing a gated feedforward network for dimensionality reduction, compressing it into a Bₙ-dim vector; finally, a Softmax layer is used for weight calculation, resulting in trainable weight proportions, which can be expressed as the formula:
$${W}_{n}^{l} = [ {w}_{n , 1}^{{}_{{}_{{}_{l}}}} , {w}_{n , 2}^{l} , … , {w}_{n , {B}_{n}}^{l} ] = softmax ( G F FN ( {Ξ}_{n}^{l} ) )$$
where
$${W}_{n}^{l}$$
is the weight matrix of the n-th variate,
$${w}_{n , {b}_{n}}^{{}_{{}_{{}_{l}}}}$$
is the weight assigned to each temporal enriched feature vector
$${V}_{n , {b}_{n}}^{l} ,$$
softmax is a exponential normalization operator, GFFN is the gated feedforward network layer, and Bₙ is the total number of branches;
Step 3.2: feature vectors augmentation, which utilizes the gated feedforward network to perform nonlinear control on the Bₙ temporal enrichment feature vectors generated in the patch-series attention layer, and further promotes their feature expression, which can be represented by the formula:
$${\tilde{V}}_{n , {b}_{n}}^{{}_{l}} = GFF N ( {V}_{n , {b}_{n}}^{l} )$$
where
$${V}_{n , {b}_{n}}^{l}$$
is the bₙ-th temporal enriched feature vector of the n-th variate generated in the patch-series attention layer,
$${\tilde{V}}_{n , {b}_{n}}^{{}_{l}}$$
is the modified bₙ-th temporal enriched feature vector of the n-th variable;
Step 3.3: feature fusion, which employs self-learning weights
$${w}_{n , {b}_{n}}^{l}$$
for further modified feature vector
$${\tilde{V}}_{n , {b}_{n}}^{{}_{l}}$$
to perform weight allocation, and then the weighted sum is calculated to obtain the fused full-scale temporal feature vector, which can be expressed as the formula:
$${\tilde{V}}_{n}^{{}_{l}} = {\sum }_{{b}_{n} = 1}^{{B}_{n}} {w}_{n , {b}_{n}}^{l} {\tilde{V}}_{n , {b}_{n}}^{{}_{l}}$$
where
$${\tilde{V}}_{n}^{{}_{l}}$$
is the fused full-scale temporal feature vector.

6. The method as claimed in claim 5 wherein said variate-wise attention layer utilizing the attention mechanism among multivariate variables for correlation fusion, and said gated feedforward network layer introducing a gating mechanism into the feedforward network, enabling it to adaptively skip or limit unfavorable nonlinear activations and excessively deep structures, which can be expressed as the formula:
$${h}_{1} = GELU ( {w}_{1} {V}_{n}^{l} + {b}_{1} ) \\ {h}_{2} = {w}_{2} {h}_{1} + {b}_{2} \\ GLU ( {h}_{2} ) = σ ( {w}_{3} {h}_{2} + {b}_{3} ) ⊙ ( {w}_{4} {h}_{2} + {b}_{4} ) \\ GFFN ( {V}_{n}^{l} ) = N o r m ( {V}_{n}^{l} + G L U ( {h}_{2} ) )$$
where
$${V}_{n}^{l}$$
represents the input data stream of the module, σ(⋅) and GELU(⋅) are the activation functions, h₁ and h₂ are intermediate variates, w and b are learnable parameters, GLU is the gated linear unit, ⊙ is a matrix dot-product operator, and
$$GFFN ( {V}_{n}^{l} )$$
is the output of the module.

7. The method as claimed in claim 1 wherein a linear projection layer is used as the decoder of the model in step 4 to reconstruct the generated temporal feature vectors with highly enriched feature information generated in step 3 and adjust the vector length. By utilizing a linear fully connected neural network, the feature vectors are spatially mapped to obtain the final predicted sequence of the specified length.

8. The method as claimed in claim 1 wherein said metrics MSE can be calculated as:
$$M S E = \frac{1}{n} {\sum }_{i = 1}^{n} {( y - \hat{y} )}^{2}$$
where y is the prediction value and ŷ is the true value, and n denotes the length of sequence.

9. A non-transitory computer-readable storage medium having a computer program stored thereon, wherein when said computer program is executed by a processor, causing said processor to carry out said method for multivariate time-series long-term forecasting based on multi-scale temporal feature enhancements in claim 1.

10. An electronic device comprising a memory, a processor and a computer program stored on said memory and runnable on said processor, wherein when said processor executes said computer program, causing said processor to carry out said method for multivariate time-series long-term forecasting based on multi-scale temporal feature enhancements in claim 1.
